(19) United States
(12) Patent Application Publication
(10) Pub. No.: US 2007/0244819 A1
(43) Pub. Date: Oct. 18, 2007

(54) Decoder and System for Processing Pay-Tv Data and Process for Managing at Least Two Decoders

(76) Inventors: Maxime Goeke, Singapore (SG); Michael John Hill, Coppet (CH); Marc Uldry, Attalens (CH)

Correspondence Address: HARNESS, DICKEY & PIERCE, P.L.C., P.O. BOX 8910, RESTON, VA, 20195, US

(21) Appl. No.: 10/561,516

(22) PCT Filed: Jun. 18, 2004
(86) PCT No.: PCT/IB04/50934

§ 371 Date: Feb. 13, 2007

(30) Foreign Application Priority Data
Jun. 20, 2003 (CH) 2003 1082/03

(51) Int. Cl. H04N 7/16

(52) U.S. Cl. 705/52

(57) ABSTRACT

This invention concerns a decoder for processing Pay-TV data. This decoder is associated to a security module by means of identification data and includes means for deactivating the processing of the Pay-TV data. Furthermore, it includes a counter that acts on the deactivation means according to the content of this counter. The invention also concerns a Pay-TV data management system including at least two decoders like those defined above, this system being characterized in that at least one of the security modules is declared master and includes means for reinitializing said decoder counters. The invention furthermore concerns a management process for at least two decoders for processing Pay-TV data, said decoders being associated to a subscriber and including means for deactivating the processing of Pay-TV data and a counter that acts on said deactivation means. Each subscriber also disposes of at least two security modules that can be locally connected to a decoder. The process includes the steps of determination of at least one master security module among the security modules belonging to a subscriber; of storage in each of the subscriber's decoders of an identification element of the master security module; of deactivation by the data processing decoder counter according to at least one predefined criterion and the reinitialization of the counter by introducing the master security module into the deactivated decoder.

This invention relates to a decoder for processing Pay-TV data. It also concerns a Pay-TV data management system as well as a management process for at least two decoders for processing Pay-TV data.

Generally, to be able to access an encrypted content corresponding to events broadcasted by Pay-TV operators, such as films, sport events or the like, it is necessary to purchase a subscription, a decoder and a security module. Some subscribers wish to dispose of several decoders and several security modules so that several users can access events broadcasted from several TV sets placed in different rooms of their house.

In this case, the price for further subscriptions, decoders and/or security modules is generally lower than the price of the first subscription, decoder and/or security module. However, the intention is to try to avoid the situation where a subscriber acquires several decoder/security module sets, thus benefiting from the price reduction for further sets and then allowing a third person, who is not a subscriber, to take advantage of this reduction or resell these sets at a lower price than the normal purchase price.

A solution to avoid this situation consists in imposing an operation that is not very restrictive for a subscriber who genuinely disposes of several decoders associated to the security modules in his house, but that on the contrary is very restrictive for a subscriber who has resold the decoders and the security modules, or for the buyer of said modules. Furthermore, if this operation is not carried out, the decryption of the transmitted content is not possible.

A system allowing the partial achievement of this aim is described in the European patent published under the number EP 0 826 288. This patent describes a Pay-TV system comprising several TV sets, each set being connected to a specific subscriber. Each set is formed of at least two decoders, each decoder being associated to a smart card intended to allow the decryption of the content sent to the decoders connected to the television system. Each smart card contains a certain amount of data that allows its identification. This information, called “chaining data”, is for example a signature, a key or another identifying element. All the cards connected to the same subscriber have at least one chaining data in common. The cards of different subscribers cards do not have any data in common.

The subscriber's smart cards, or at least one of them, can be deactivated according to preset criteria. These criteria can for example be a determined date or a utilization period. When a card is deactivated, the control words are no longer deciphered. The content sent to the decoder in question can no longer be deciphered without these control words corresponding to broadcasted events.

A deactivated card can be reactivated if the subscriber disposes of a card that is still active and of a decoder connected to the same subscriber. To carry out this operation, the prior art system according to this invention operates in the following way.

The data connected to an active card is first stored in the decoder into which this card is introduced. When a card is deactivated, it must be introduced into a decoder associated to an active card of the subscriber. The chaining data, such as the signature, the key, etc., stored in the decoder, is authenticated with the chaining data of the deactivated card. If this data paires, the counter containing, for example, the next deactivation date or the utilization period is increased in such a way as to allow the use of the card during a certain time. If this chaining data does not pair, the counter is not reinitialized in the deactivated card, the decryption of the control words is not possible and the event remains encrypted.

In this system, regardless of which decoder is connected to an active subscriber's card, the reactivation of a deactivated card is permitted if the chaining data corresponds, that is to say if they belong to the same subscriber. In this way, if a subscriber's cards have been sold to individuals located geographically close to the initial subscriber, the individuals who have a deactivated card can introduce this card into any decoder connected to an active subscriber's card to make theirs work again. The deterrent aspect aimed for in the invention is thus only partially achieved.

Furthermore, there is a simple way to avoid the inherent constraints related to the process of this patent. It is sufficient for the buyer of an unauthorized decoder set/card to simply buy two sets. Thus, he will always be able to reactivate a card when it is deactivated.

Another problem arises when all the cards are deactivated. This can occur in particular if a subscriber rarely watches TV or if he is absent from the moment when the first card is deactivated to the moment when the last card is deactivated. In this case, it is no longer possible to reactivate a card and the only solution consists in ordering another card.

In the invention described in this publication EP 0 826 288, all the important data, that is to say essentially the chaining data and the data related to the deactivation date, are stored in the card. The decoders only play the role of “buffer memory” in order to transfer the chaining data between an active card and another deactivated card during the reactivation process.

Another invention that allows the above-mentioned aim to be achieved is described in the publication U.S. Pat. No. 5,748,732. This document concerns a Pay-TV system including a master decoder and one or more slave decoders, equipped with smart cards. The smart cards of the slave decoders have a relatively short limited validity duration, which means that once the validity duration has lapsed said cards can no longer decrypt encrypted data. In order to reactivate a smart card the validity duration of which has elapsed, a management centre sends an authorization message EMM to the master decoder. The latter processes it in such a way as to extract the new functioning data of the slave smart card. This data is stored in the master decoder. When the user wishes to reactivate his slave card, he must introduce it into the master decoder that transfers the stored data to this card. The card will work again when it is introduced into the slave decoder.

In this embodiment, as previously, all the important data and in particular the data related to the working duration of the slave cards is stored in the cards themselves. The master decoder only plays the role of “buffer memory” in order to transfer the updating data from the master card to a slave card. In particular, this decoder does not include a counter capable of managing the activation duration of a card.

This invention proposes to offer an alternative solution that ensures security and control for the access to the events sent by the operator. The aim of this invention is to allow the flexible management of the working duration of a decoder and to adapt the working parameters by means of the security module at any moment.

Furthermore, this device aims to manage each subscriber in a global way. Thus, a subscriber who resells one or more decoder/security module sets will be charged with the invoices of the events watched by the users of these sets. This strongly increases the deterrent effect that forms part of the aim of this invention.

Furthermore, the invention also allows the collection and management of the data supplied by the decoder/security module sets, such as for example, service data or the data related to the impulsive purchase of events, both regarding invoicing and statistics.

The aims of the invention are achieved by means of a decoder for processing Pay-TV data, this decoder being associated to at least one removable security module by means of identification data contained in said decoder and in the security module, this decoder including a descrambling module, the decoder being characterized in that it furthermore includes means to deactivate the processing of Pay-TV data as well as a counter acting on said deactivation means according to its content.

These aims are also achieved by a Pay-TV data management system including at least two decoders, each decoder being associated to at least one removable security module by means of identification data contained in said decoder and in said security module, these decoders including a descrambling module and means to deactivate the processing of the Pay-TV data, this system being characterized in that the decoders furthermore includes a counter that acts on said deactivation means, and in that at least one of the security modules is declared as master and includes means for reinitializing said decoder counters.

These aims are furthermore achieved by a management process for at least two decoders for processing Pay-TV data, said decoders being associated to a subscriber and including means to deactivate the processing of Pay-TV data and a counter that acts on said deactivation means, each subscriber having at least two removable security modules that can be locally connected to at least one decoder, this process comprising the steps of:
determining of at least one master security module among the security modules belonging to a subscriber,
storing of the identification data of the master security module in each of the subscriber's decoders,
deactivating, by means of the counter, of the data processing decoder according to at least one predefined criterion,
reinitializing of the counter by introducing the master security module into the deactivated decoder.

The invention will be better understood thanks to the following detailed description that refers to the enclosed drawings, given as non-limitative examples, in which:

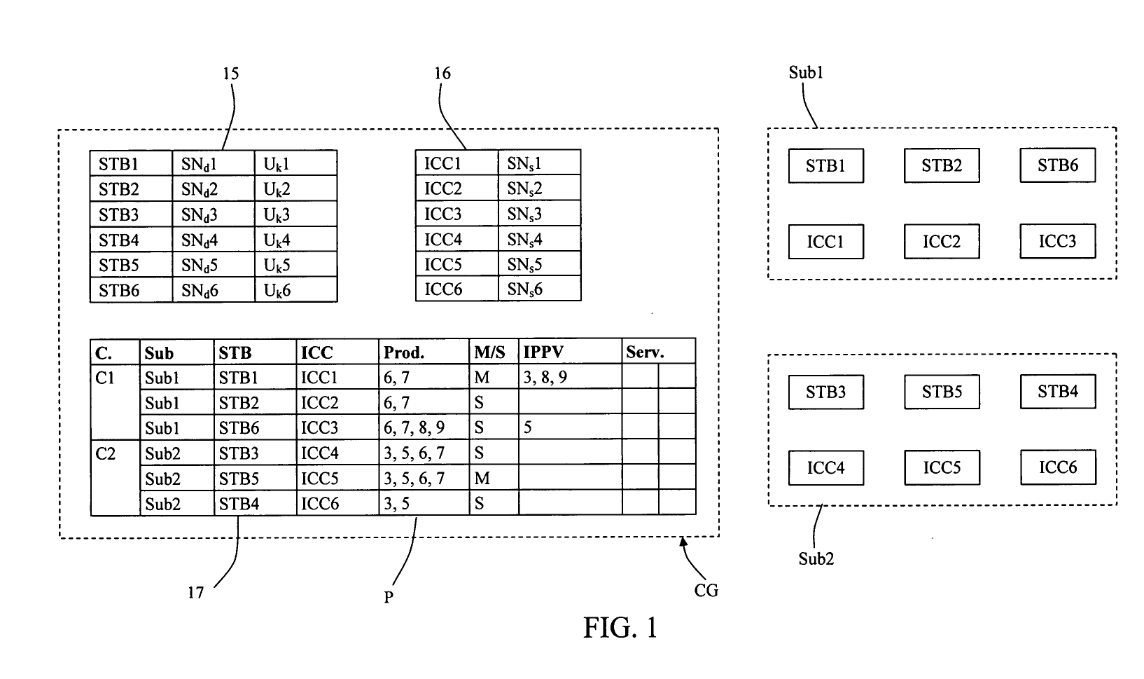

FIG. 1 shows on one hand the elements at a subscriber's home and on the other hand those at a Pay-TV events broadcaster centre;

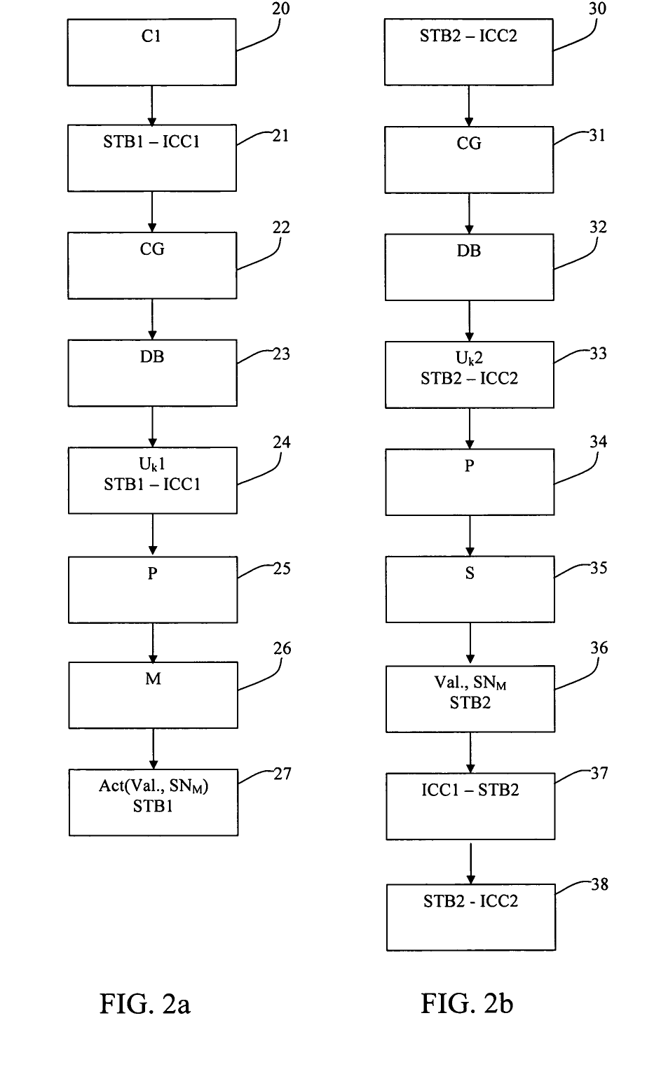

FIG. 2a is a bloc diagram representing the operations related to the activation of a first decoder, according to a first embodiment;

FIG. 2b is a bloc diagram representing the operations related to the activation of a second decoder for the same subscriber, according to the embodiment of FIG. 2a;

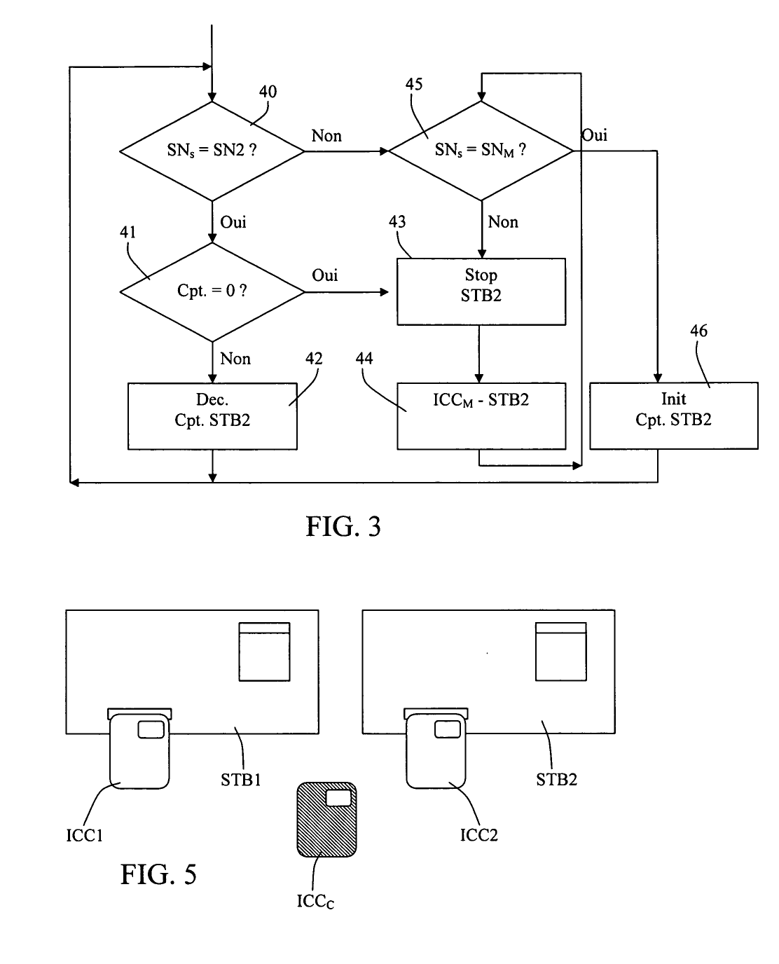

FIG. 3 is a bloc diagram representing a part of the functioning of the invention's device;

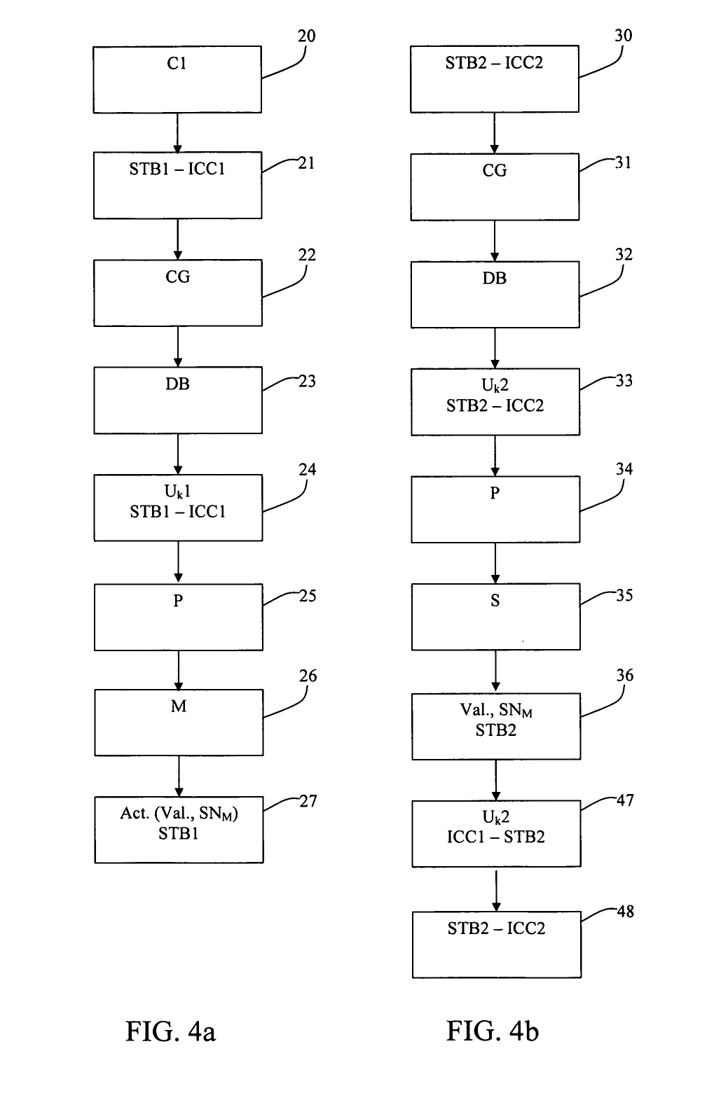

FIG. 4a is a bloc diagram representing the operations related to the activation of a first decoder, according to a second embodiment;

FIG. 4b is a bloc diagram representing the operations related to the activation of a second decoder for the same subscriber, according to the embodiment of FIG. 4a;

FIG. 5 represents the system according to the invention, working according to a third embodiment;

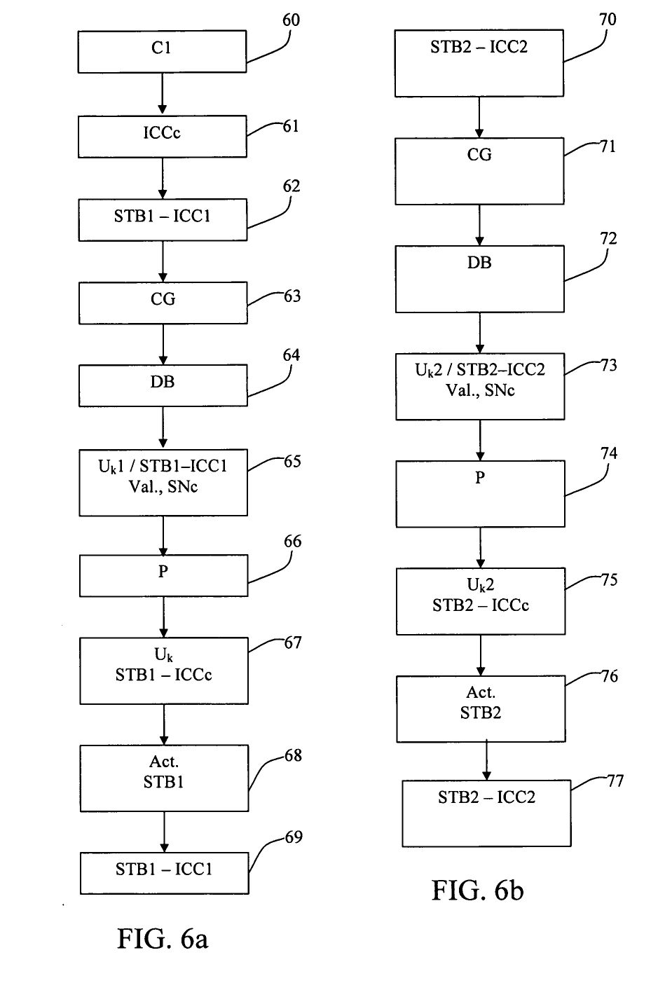

FIG. 6a is a bloc diagram representing the operations related to the activation of a first decoder, according to a third embodiment, also disclosed in FIG. 5;

FIG. 6b is a bloc diagram representing the operations related to the activation of a second decoder for the same subscriber, according to the embodiment of FIG. 6a;

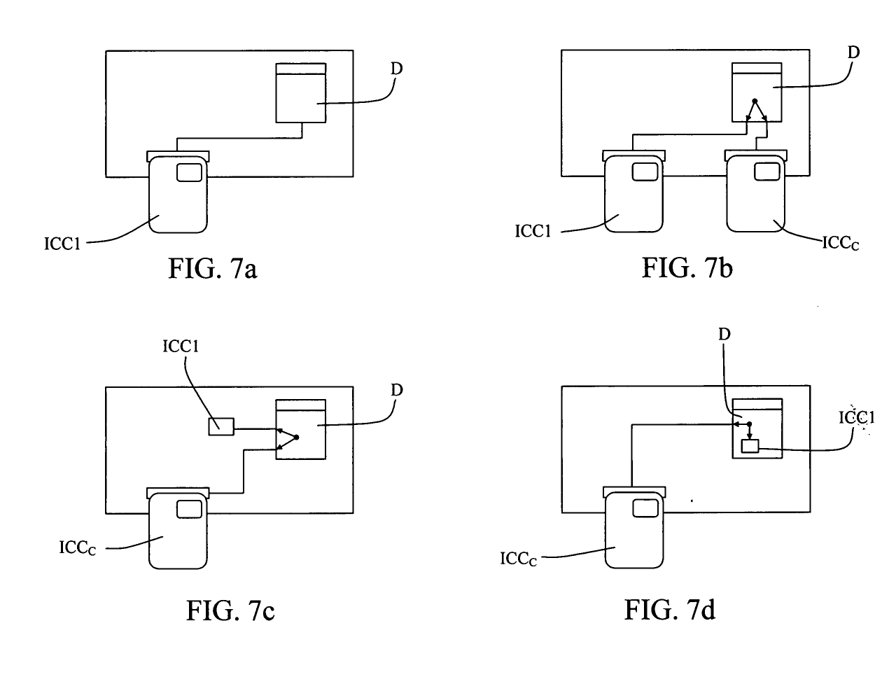

FIGS. 7a, 7b, 7c and 7d represent possible architectures of the device according to the invention.

The invention is described below with reference to several embodiments, in which it is assumed that the subscriber disposes of several decoders STB1, STB2, STB3, . . . each of them being associated to a security module ICC1, ICC2, ICC3, . . . , which can for example be in the form of a microprocessor card or smart card or in the form of an integrated-circuit. Each decoder includes a descrambling module arranged to process the encrypted data and allow it to be viewed in clear, a memory intended to store identification data, and deactivation means arranged to authorize or forbid the access to the Pay-TV data.

According to a first embodiment shown in FIGS. 2a and 2b, when the user acquires a first Pay-TV subscription contract, C1, which is illustrated by step 20 in FIG. 2a, he also acquires a first decoder STB1 associated to a first security module ICC1. This is illustrated by reference 21 in FIG. 2a. As it is well known to those skilled in the art, the security module manages the rights associated to the events and sends the control words back to the decoder to allow the latter to process the Pay-TV data and therefore to decode the encrypted content connected to an event.

When the subscriber has acquired all the elements necessary for the decryption of events, namely a subscription, a decoder and a security module, he must first activate these elements in such a way as to render them functional. Without this activation, the arrangement is not capable of processing the Pay-TV data.

According to a concrete embodiment, when the subscriber wishes to activate his decoder STB1 and his security module ICC1 for the first time, he must call a management centre CG and state the identification data, in particular an identification number C1 connected to his subscription contract, a unique identification number SNₛ connected to the security module, a unique identification number SN_{d} connected to the decoder and possibly his name (Sub1, Sub2) for verification purposes.

This is illustrated by reference 22 in FIG. 2a. The identification numbers are also commonly called series numbers. These operations are generally carried out by the operator who installs the system at the subscriber's home.

This information will be used by the management centre to register the subscriber (Sub1, Sub2), in connection with the decoder STB and the security module ICC that he has acquired and in order to pair the decoder and the security module. It should be noted that the decoder and the security module can be purchased separately, so that before the call at the management centre, the latter does not have any means to know which security module is associated to a certain decoder.

As disclosed under the general reference CG in FIG. 1, the management centre contains at least one database where data is stored which allows the connection of the security module with the decoder. More particularly, the management centre contains, in its database, the unique identification number SN_{d} of each decoder STB managed by this centre. This unique number is associated to at least one encryption key Uₖ (of the symmetrical or asymmetrical type) that is different for each decoder. This encryption key, called the “pairing key”, is also stored in the decoder itself. When the subscriber has identified his decoder by means of the unique number SN_{d} and has indicated the unique number SNₛ of the security module, the management centre connects, in the database, the security module with the decoder. In FIG. 1, the content of the database is represented in the form of three tables. One of the tables 15 contains the list of all the decoders STB managed by the management centre, associated to their unique identification number as well as to their pairing key Uₖ.

Another table 16 contains the list of all the security modules ICC as well as their unique identification number SNₛ. The third table 17 contains the list of the subscription contracts C1, C2, . . . and the subscribers Sub1, Sub2, . . . each associated on one hand to their decoders STB and on the other hand, to their security modules ICC. This table also contains the list of the products P acquired by the subscriber as well as an indication of function as master M or slave function S, the role of which is explained below. This table 17 can also be used to store other data, called service data, as is also explained below. The products P, that is to say in particular the events that the subscriber is authorized to view, can be connected to the subscription contracts or to the security modules. This means that the products can be the same for all the security modules of a subscriber or on the contrary can be different for the different modules. Therefore, it is for example possible to limit the products accessible from a certain decoder/security module set. These products can be channels, a multichannel package or events that are well known to those skilled in the art. The step including data research and link creation in the database has the reference 23 in FIG. 2a.

The encryption key Uₖ 1 connected to the unique number SN_{d} 1 of the decoder STB1 still has to be transmitted to the security module ICC1 in order to be able to encrypt the communications between this security module and the decoder. This key is generally sent in a management message EMM encrypted by means of a private global key of the operator, which is the same for all the security modules managed by this operator. The decoder associated with the security module, for which this message is intended, can receive and transmit said message to the security module which decrypts the message by means of the public global key of the operator and extracts the pairing key Uₖ 1. This pairing key is stored in a memory of the first security module ICC1 with the unique number of the decoder SN_{d}. The pairing step has the reference 24 in FIG. 2a. In a further step 25, the decryption rights for the products P as deduced from table 17 of the database are loaded in the security module.

The database of the management centre attributes a master function M to the security module connected to this first decoder, which is represented by the reference 26 in FIG. 2a.

When all the data has been introduced into the database and the pairing key Uₖ 1 has been transmitted to the security module, the decoder STB1 must be activated to allow decoding, as illustrated in step 27. The management centre then sends a “decoder command” to the decoder STB1 in question. A “decoder command” is a command intended for the decoder, transmitted in the form of an authorization message EMM, and processed by the security module as the decoder does not dispose of the sufficient security means to process this command directly. The authorization message EMM is transmitted in encrypted form by means of the global key of the operator. This message is decrypted by the security module by means of the global key. Given that the security module can determine that it is not concerned by this command, said module encrypts said command by means of the pairing key Uₖ 1 and then sends it back to the decoder which decrypts said message and applies the command.

This “decoder command” contains identification data of the master security module, this data generally being its identification number SN_{M} or it can be other data that allows the identification of the security module, and a deactivation value which is generally a temporary value. The identification data is stored in the decoder memory and the deactivation value is attributed to a decoder counter. It should be noted that in the example disclosed, the identification number SN_{M} of the master security module is the same as the identification number of the first security module S_{N} 1, as this first security module has the master function.

At this step, the decoder requests the unique number SNₛ of the security module and compares said number with that received in the message containing the “decoder command”. If these values are the same, which is of course the case if the original module has not been replaced by another module, the decoder acts on the deactivation means in order to unblock the transfer of the events ECM control messages towards the security module and the control words can be decrypted. The decoder counter is also activated. If the subscriber has only one decoder and only one security module, they work in a paired way, as described in application WO 99/57901, and the decryption of the encrypted events is carried out in a conventional way.

In the description above, the exchanges between the security module and the decoder are carried out in an encrypted way by means of the pairing key Uₖ 1. However, It is possible for these exchanges to be encrypted by means of a session key, which is different from the pairing key but which derives from it.

When the subscriber wishes to purchase a second decoder, he must of course acquire a second security module. The activation of the second decoder is represented in its entirety in FIG. 2b. The purchase of a second decoder STB2 and of a second security module ICC2 is represented by the reference 30. As previously, the subscriber must call the management centre CG and state the identification data and in particular the unique numbers SN_{d} 2 and SNₛ 2 of the second decoder STB2 and of the second security module ICC2, the subscription number C1 and possibly his name Sub1 for verification, in step 31 in FIG. 2b. A search for the necessary data is carried out in the database in step 32 and the database is completed, as explained with reference to FIG. 2a. The database allows the pairing key Uₖ2 to be found which is then stored in the decoder STB2. This pairing key Uₖ2 is associated in the database to a unique number SN_{d}2 of the second decoder STB2. This pairing key Uₖ2 is sent, in step 33, to the second security module ICC2 in order to allow encrypted communication between the security module and the decoder. The list of the products is also sent to the second security module ICC2 by the management centre, during step 34. In the management centre database, a slave function S is attributed to the second security module ICC2 in step 35. As previously, a “decoder command ” is sent to the second decoder in the form of an encrypted authorization message EMM, this command containing a deactivation value as well as the identification number SN_{M} of the master security module. This corresponds to step 36 in FIG. 2b. As previously, these two data are stored in the decoder, the identification data being stored in the memory and the deactivation value being attributed to a counter of this decoder.

At this point, the decoder and its security module are not activated, so that the decryption of broadcasted events encrypted by the operator is not yet authorized. The decoder and the security module with a slave function must be activated by the master security module ICC_{M}, which in the example above, corresponds to the first security module ICC1. To obtain this, a message is displayed for the subscriber, requesting the latter to insert the first security module ICC1 or master security module ICC_{M} into the second decoder STB2 or slave decoder S. This is represented by reference 37 in FIG. 2b. At the same time or after the display of the message, the decoder sends a command to the security module that said decoder contains, with the aim of obtaining the identification number SNₛ of this module. This number is compared, using means for comparing the identification data, with the identification number of the master security module SN_{M} originating from the management centre CG and stored in the second decoder. If these two numbers pair, the decoder activates the processing of the stream and starts the counter of this decoder. It also displays a message for the user, requesting the latter to reinsert the second security module ICC2 into the second decoder STB2. When this reinsertion has been carried out, the deactivation means are set in function so that the Pay-TV data can be processed and the events can be visualized. The activation of the second decoder STB2, represented by reference 38, is then completed.

In the case where the subscriber purchases a third or an n^{th} decoder, the operations proceed in the same way as for the second decoder. The subscriber identifies himself at the management centre CG and states the unique number SN_{d} of the decoder and the unique number SNₛ of the associated security module. These elements are registered as slaves S. The pairing between the slave security module and the decoder is carried out in a conventional way, as is the case for the loading of the products P.

The decoder then memorizes a temporary value and the unique identification number SN1 of the master module contained in the “decoder command” transmitted by the management centre. This value can be different for each security module/decoder pair or can be the same for some of them or for all. At this point, the slave decoder STBn requests the unique number of the security module. If this number is that of the master, the decoder is activated. In order to view the events, it is however necessary to reinsert the corresponding slave security module into the decoder.

It should be noted that in the description, it is assumed that the first security module is also the master security module, which is of course true when the subscriber only has one decoder/security module set. On the other hand, if the subscriber has several decoders, the first can be registered as master by default, but it is possible to decide to assign this master function to any other decoder. For this, the request must be made at the management centre that will then adapt the parameters in the database, in the concerned security modules and in all the decoders. Only one security module of a determined subscriber is assigned the master function, all the other security modules are considered as slave.

Following the procedures explained above, the subscriber's different decoder/security module sets allow the decryption and viewing of Pay-TV events. The temporary deactivation value stored in a counter of each decoder is used to manage the deactivation means and to prevent decryption according to certain criteria, in particular after a certain time.

In a first embodiment example, the temporary deactivation value is supposed to correspond to a certain duration, for example 30 days. The decoder is thus deactivated after this duration of 30 days. The deactivation value is stored in the counter of each decoder.

Under normal operating conditions, that is to say when the security module is introduced into the corresponding decoder, the value of the counter stored in the decoder decreases at regular intervals, for example every day or every hour, by the number of sets that will make the counter reach a zero value when the predetermined duration has lapsed. It is also possible to make provision for the counter to increase until it reaches a predetermined value. This is illustrated in FIG. 3. In this Figure, it is assumed that the security module ICC1 is the master module and that the module ICC2 is the slave. The decoders STB1 and STB2 are respectively associated to the modules ICC1 and ICC2. In step 40, the decoder questions the security module that it contains at regular intervals, to determine its identification number SNₛ. If this number is the same as the identification number of the second security module SN2, it is verified, in step 41, if the value of the counter is zero.

If this is not the case, the counter of the second decoder is decreased according to a preset rule. This is carried out in step 42 of FIG. 3.

If this counter value is zero or has reached a predetermined value, which is illustrated by reference 43, the deactivation means are used in such a way that the subscriber can no longer view the events. Within the scope of the deactivation means, several possibilities can be implemented to deactivate the access to the Pay-TV data. It is possible to force the decoder to block the transmission of the control messages ECM containing the data relating to the events towards the security module, so that these messages do not arrive at the security module. It is also possible to force the decoder not to receive the decrypted control words sent in return by the security module. Another possibility consists in blocking the transmission of the sound and the images coming from the descrambling module of the decoder. In this case, the decryption is carried out as usual, but the user does not receive anything on his television set display. In all cases, it is the decoder that is in charge of blocking the display of the events.

When the value of the counter is zero or has reached a preset value, it is necessary to reactivate the set to allow the decryption of the events. It should be noted that according to the embodiment, it is not necessary to wait for the value to reach zero to reactivate the set. It is possible to carry out a reactivation more rapidly by restarting the value of the counter and thus avoid the counter from reaching zero. To this end, the decoder can dispose of means to indicate the advancement of this counter.

The reactivation of a decoder that has been deactivated because the counter has reached a zero value takes place in the following way. Let us suppose that the counter of the second decoder STB2 has reached a zero value or a preset value so that it is deactivated. The security module ICC2 paired with the deactivated decoder is withdrawn from this decoder. The master security module or first security module ICC1 is introduced into this decoder in step 44 of FIG. 3. The slave decoder STB2 sends a command in order to obtain the unique identification number of the security module that is in this decoder. The latter then verifies, by the comparison means, if the unique identification number SNₛ of the master security module is identical to the identification number SN_{M} that the decoder stored during its initialization. This is carried out in step 45 of FIG. 3. If these numbers correspond, the counter of the decoder is reinitialized in step 46 and a new temporary deactivation value is introduced into the counter. This deactivation value is generally the value stored in the decoder. It should be noted that the value stored in the decoder can be modified by means of an authorization message EMM sent by the management centre. In this case, the new value stored in the decoder is applied at each reactivation. It can also be a value received directly from the management centre by an authorization message EMM addressed to the security module. If this new value is not stored in the decoder, it is only applied for the reactivation in progress. The master security module can then be withdrawn and the slave security module ICC2 paired with this decoder can be reintroduced in order to decode the encrypted content sent by the operator. If the identification number of the master module does not correspond, the counter is not reinitialized and the events cannot be viewed. The instructions for the subscriber are preferably displayed on the screen of the television set associated with the deactivated decoder so that the subscriber only has to carry out the operations step by step.

In a preferred embodiment, it is not necessary to wait for a message to appear on the television screen to generate the reinitialization of the counter. This can in fact be carried out at any moment by introducing the master security module into one of the slave decoders.

According to an option, it is possible to increase the counter “manually” to a value corresponding to a relatively short period of time, for example 2 hours. This gives the user the time to finish viewing an event in progress despite the fact that the counter of the decoder has reached a zero value. According to another option, it is also possible to display a warning message for the subscriber, indicating to him that the security module can still work for a relatively short period, for example 48 hours.

This can be achieved by determining the value of the counter at regular intervals. The subscriber thus disposes of a certain time period to increase the counter by introducing the master security module before the security module is deactivated.

The first security module associated to the first decoder, to which the master statute is assigned, operates like the slave modules. However, as in general this first security module is placed in the first decoder, the counter is reinitialized at regular intervals. In normal use, when this counter falls to zero, it is immediately reinitialized by the master security module. The master security module and the associated decoder can thus usually always decrypt the events.

According to a different embodiment, the decoder sends a command at regular intervals to obtain the unique identification number of the security module that is introduced into this decoder. If this identification number is that of the master module, the counter is reinitialized. In this case, the decoder connected to the master module never falls to zero in normal use, that is to say when the master security module is placed in the corresponding decoder.

This alternative is also advantageous for the user of decoders connected to slave security modules, since it allows a counter to be reinitialized at any moment, regardless of the real value contained in the counter. In this case, it is possible to leave the master security module in one of the decoders connected to a slave module until the next identification number search command is generated by the decoder. It is also possible to provide the manual activation of this control by the user or an automatic command that is initialized as soon as a security module is introduced into a decoder.

It is also possible to make provision for the interval between two commands seeking the identification number to be relatively long when the value of the counter is high and then to decrease when this counter value decreases. So, if a warning message informs the subscriber that the master security module must be introduced into a given decoder in a relatively short time period in order to avoid the counter falling to zero, the subscriber must leave his master security module in the decoder to be reinitialized until the next command to obtain the identification number is transmitted by the decoder. This duration can typically be in the region of few hundred milliseconds.

In another different realization, the counter contains a determined date. The data stream sent by the management centre to the decoder contains a signal representing the hour and the date, this signal being known under the acronym TDT (Time & Date Table). The slave decoder, at regular intervals, compares the value of the counter to the current value of the date, given by the signal TDT. As long as the date of the counter is later than the current date, the slave decoder operates in a conventional way, namely the decryption of the content can be achieved.

When the actual date, sent by the TDT signal is later or equal to the date of the counter, the decoder blocks the transfer of the control messages ECM to the security module so that the content of the events can no longer be decrypted. It should be noted that, as previously, the counter can be manually increased by a few hours, to avoid having to carry out an updating operation while the subscriber is viewing an event. A message is displayed for the subscriber, requesting him to insert the master security module into the slave decoder.

According to an embodiment variant, the counter includes a numerical value that corresponds to a certain number of temporal pulses. The data stream in which the events are contained includes time data sent at regular intervals. Every time the decoder receives a pulse, it decreases the counter, for example, by one set. It is also possible to vary the interval between two pulses in order to adjust the interval between two reactivations.

In these variants, the management centre can encrypt the values of the counter in a “decoder command” specifically addressed to a security module or to a group of modules. The security module to which this control is addressed decrypts this type of command and sends it back, encrypted with the pairing key, to the decoder that applies the command which is destined to it and thus modifies the value of the counter in consequence.

As previously described, the increase of the counter of the slave decoders is carried out according to a temporary value stored in the decoder to be restarted. It is also possible to send an authorization message EMM to a particular decoder, in a “decoder command”, imposing a temporary deactivation value on this decoder. In this case, this new value is only applied to this decoder or to the decoders to which the message is destined. This method allows, for example, the immediate deactivation of a decoder that is suspected of having been sold without authorization.

In a second embodiment of the invention, shown in FIGS. 4a and 4b, when the user purchases a first Pay-TV subscription contract, C1, he also buys, as previously, a first decoder STB1 associated to a first security module ICC1. The activation of the decoder/security module set occurs exactly as described with reference to FIG. 2a. The references in FIG. 4a are thus the same as those in FIG. 2a.

In short, a search is carried out in the management centre CG database DB for the data connected to the user, to his first decoder and his first security module. The pairing key Uₖ 1 is transmitted to the security module in the same way as the products and the master function. A “decoder command” containing a temporary deactivation value as well as the identification number of the master security module is sent to the decoder. The assembly is activated so that it is possible to decrypt data and view events.

When the subscriber wishes to purchase a second decoder, he must of course acquire a second security module. The activation of the second decoder is represented in its entirety in FIG. 4b. In a first part of the process, namely in the steps with the references 30 to 36, this activation progresses in the same way and which described with reference to FIG. 2b. The subscriber thus calls the management centre, which searches for the pertinent data in its database. The pairing between the second security module ICC2 and the second decoder STB2 is carried out in a conventional way by means of the transmission of the pairing key Uₖ ² to the security module. The rights associated with the products are also transmitted as previously, then a “decoder command ” containing a temporary deactivation value and the identification number of the master security module is sent to the decoder.

The following step 47 differs from the step described in the embodiment of FIG. 2b. In fact, in step 47, there is a pairing between the master security module ICC_{M} or first security module ICC1 and the second decoder STB2. For this, a message is displayed for the subscriber, requesting him to insert the first security module ICC1 or master security module M into the second decoder STB2 or slave decoder S. During this activation step, the management centre CG sends a message encrypted by the global key of the operator to the master security module, this message containing the pairing key Uₖ 2 between the second decoder STB2 and the second security module ICC2. This key is thus used to encrypt the communications of the second decoder STB2 either with the first security module ICC1 or with the second security module ICC2. This key is stored in a pairing table stored in the master security module.

At this point, the slave decoder STB2 requests the unique number of the security module. If this number is that of the master module SN_{M}, the decoder activates the processing of the data stream and the events can be viewed. The activation of the second decoder STB2, represented by reference 47, is then completed. It should be noted that to view an event, it is necessary to reinsert the second security module ICC2 into the second decoder STB2, which corresponds to step 48 in FIG. 4b. It is possible to allow the master security module to decrypt events from any decoder, but in practice, this is not desirable. Decryption is generally authorized when a decoder is associated to only one security module and conversely.

In the case where the subscriber acquires a third or an n^{th} decoder, the operations proceed as for the second decoder. The subscriber identifies himself at the management centre CG and states the unique number SN_{d} of the decoder and the unique number SNₛ of the associated security module. These elements are registered as slaves S. The loading of the products P and the pairing between the n^{th} decoder STBn and the n^{th} security module ICCn are carried out in a conventional way by means of a pairing key Uₖn. Pairing is then achieved between the decoder identified as STBn and the master security module ICC_{M} or first security module ICC1, by means of the pairing key Uₖn. The decoder then stores a temporary value and the unique identification number SN1 of the master module contained in the “decoder command” transmitted by the management centre in the decoder command. This value can be different for each security module/decoder pair or can be the same for some or all of them. The activation of the module/decoder assembly is carried out by means of the master security module. The decryption of the events is possible when the n^{th} security module ICCn is introduced again into the n^{th} decoder STBn.

The deactivation of the decoders, in this embodiment, occurs in the same way as explained with reference to FIGS. 2a and 2b.

Basically, the reactivation of a decoder is similar in the embodiment described in FIGS. 4a and 4b and in that described in FIGS. 2a and 2b. However, in the embodiment of FIGS. 4a and 4b, the decoder does not simply verify the unique identification number of the master security module. In fact, a true authentication of this module is carried out. Different authentication methods are possible. One of these methods is described below. The slave decoder, for example STB2, generates a random number that it sends in plain text to the master security module, for example ICC1. The latter encrypts said message with the pairing key Uₖ2 intended to encrypt the communications between this decoder STB2 and the master module ICC1. Said decoder then sends the encrypted number back to the decoder STB2 that decrypts said number with the pairing key Uₖ2 and compares said number to the initial number. Likewise, an authentication can also be carried inversely. In this case, the master security module generates a random number, sends said number in plain text to the decoder that encrypts said number with the pairing key Uₖ2 and sends said number back to the security module. The latter decrypts said number and compares it with the initial number. If the comparison indicates that both values are identical, the counter is reinitialized and it is again possible to visualize the events. If the comparison indicates the contrary case, the processing of the data is not authorized.

This embodiment allows better security against the unauthorized use of an incorrect security module.

The FIGS. 5, 6a and 6b describe a particular embodiment in which the subscriber disposes of a supplementary security module in comparison with the number of decoder/security module sets.

As disclosed by reference 60 in FIG. 6a, a Pay-TV services user must first acquire a contract C1. When the subscriber purchases a first decoder STB1, he also purchases, as previously, a first security module ICC1, which is represented by step 62 in FIG. 6a. At the same time as the subscription, he furthermore acquires, during step 61, a supplementary security module, called a “contract module ” ICC_{C}. According to an advantageous embodiment, this contract module can be easily distinguished from the other security modules, for example, by using a different colour, as represented in FIG. 5.

As in the previous embodiment, the management centre CG contains a database with the unique identification number SN_{d} of the decoders and a pairing key Uₖ associated to this number. During step 63 in FIG. 6a, when a new subscriber calls the management centre to initialize his decoder, he must indicate a unique SN_{C} identification number of the contract module, a unique identification number SNₛ of the first security module, a decoder identification number SN_{d} and a contract number. These indications allow the connection of the data attached to the security module to the data attached to the decoder in the database. This step has the reference 64.

Once this information has been introduced into the database, the subscriber is requested to introduce the first security module ICC1 into the decoder STB1. This corresponds to reference 65. When this has been carried out, the management centre sends a pairing message and an initialization message. The pairing message contains the pairing key Uₖ1 between the first decoder STB1 and the first security module ICC1. The initialization message contains a temporary deactivation value as well as the unique identification number ICC_{C} of the contract module. The deactivation value is stored in the first decoder. The rights relative to the products P that the subscriber is authorized to decrypt are then loaded into the first security module during step 66.

Once this information has been introduced into the database, the subscriber is requested to introduce the contract module ICC_{C} into the first decoder STB1, which corresponds to step 67. This contract module and this first decoder are then paired, by means of the pairing key Uₖ1 stored in the database, this key allows on the one hand the pairing of the first decoder STB1 with the first security module ICC1 and on the other hand, the pairing of the first decoder STB1 with the contract security module ICC_{C}. This pairing is carried out in the same way as previously described. It should be noted that as a rule, the contract module does not allow the decryption of encrypted content. When pairing between the security module and the first decoder is completed, the user is requested to introduce the first security module ICC1 again into this decoder. An activation command is sent in the form of a “decoder command” to this first decoder STB1 during step 68, to activate the first decoder/security module set in order to allow the decryption of the events. The first security module ICC1 must still be introduced into the decoder at step 69, in order to allow the data to be processed.

When the subscriber acquires a second decoder STB2 associated to a second security module ICC2, as shown by reference 70 in FIG. 6b, he must contact the management centre during step 71. During step 72, the data connected to the subscriber and to the decoder/security module set are updated. The second decoder STB2 is then paired, during a step 73, with the second security module ICC2 in the way described above. A “decoder command” is sent to the decoder, this command containing a temporary deactivation value that can be identical to or different from the deactivation value of the first decoder, as well as the unique SN_{C} identification number of the contract module. The rights connected to the products P of the second security module are loaded during step 74. The second security module is withdrawn from the decoder and the contract module ICC_{C} is introduced into it. These two elements are paired by means of the pairing key Uₖ2 contained in the database. This pairing is carried out during step 75. The pairing key between the second decoder and the second security module is the same as the pairing between the decoder and the contract security module. The counter of the second decoder is activated during step 76.

The contract module is then withdrawn from the decoder and the second security module ICC2 is again introduced into the decoder in step 77. At this step, it is possible to view the encrypted events.

The activation procedure of a third or n^{th} decoder/security module set is identical to that explained above for the second set.

As previously mentioned, in general, the contract module is not intended to be able to decrypt encrypted content. However, on the contrary, it is possible to produce a contract module that is capable of decrypting the encrypted content from any of the decoders belonging to a determined subscriber, or to restrict the decryption capacity to one or several given decoders. The choice essentially depends on the operator broadcasting the encrypted content.

Supposing, as previously, that the temporary deactivation value of the security module is a utilization period, the counter decreases at regular intervals. When it reaches zero, the decryption of the content is blocked and a message is displayed for the user. This message indicates to the subscriber that he must reactivate his decoder/security module set. For this, the subscriber must first withdraw the security module from the decoder in question and then introduce the contract module ICC_{M} into the decoder. Authentication of this contract module is carried out either by simply verifying the unique identification number or by carrying out a true authentication by means of a random number, as described previously. The reinitialization of the counter is carried out in the same way as that described when using the first security module as master module.

As previously mentioned, the master security module ICC_{M} or the contract module ICC_{C} contains a table of pairing keys. This table allows the storage of the pairing key between the master module and each decoder of a determined subscriber. Apart from these keys, the table can also contain other data such as data relating to the “consumed” events and service data. This data is respectively illustrated by columns IPPV and Serv. of table 17 in FIG. 1. These columns represent the data normally stored in the security modules, after their transfer to the management centre.

The data relating to the consumed events notably contains the number and the identification of the events acquired by impulse purchase (known under the acronym IPPV=Impulsive pay-per-view). At present, when the impulsive purchase of events is possible, a credit for this impulse purchase is stored in the security module. This credit is reduced by an amount corresponding to the price of a determined event each time such an event is bought by impulse purchase. When the initial credit is used up, the subscriber has to call the management centre and request the reinitialization of his credit.

Using the system according to the invention, the management of the IPPV can be carried out in two different ways. The first way is that which is described above, namely the user calls the management centre to order an event. In practice, the subscriber can make the order by indicating his choice to an operator or he can, for example, use the remote control buttons.

The second way works as follows. During an impulse purchase, the data related to this purchase, that is to say in particular the identification of the event and its price, are stored. Said data can be stored in the security module ICC or in the STB decoder. When the master security module is introduced into a decoder, in particular with the aim of increasing the counter of this decoder, the data, notably but not exclusively that relating to the IPPV, are transmitted to the master security module or contract security module. In the case where the data is stored in the decoder, it can be transferred directly into this master module, in encrypted form or in plain text. In the case where the data is stored in the security module, it must first be transferred to a buffer memory area of the decoder. When the master security module is introduced into the decoder, this data is introduced into the master module table. When this data has been transferred to the master module, the counter can be reinitialized.

This data “gathering” operation by the master module or by the contract module is carried out in the same way for all the slave modules. Therefore, the master security module contains the pertinent data originating from all the modules belonging to a certain subscriber. When the master security module is introduced into a decoder comprising a modem connected to a return line, either by cable or by public telephone network, certain data or all the data are sent to the management centre. Generally, this data are sent in encrypted form. Since the management centre has all the keys, it can easily decrypt the content of the message. It is thus possible to know exactly the content of the events consumed by the subscriber, for each individual decoder, which allows all events to be globally invoiced. When this data has been transmitted to the management centre, the latter in particular knows the amount of credit balance on each security module. Therefore, said management centre can also increase this balance in order to allow the user to carry out an impulse purchase again. This also allows the flexible and reliable management of the credits attributed to each subscriber.

Precise knowledge of the events consumed by each subscriber and by each decoder of a subscriber offers numerous advantages. On the one hand, as previously mentioned, the credits attributed to the impulse purchase are very easy to manage. On the other hand, it is possible to produce all types of statistics, such as for example the utilization period of each decoder for each channel. In particular, this allows the consumed products to be determined and to fees to be paid according to actual consumption and not based on estimates. This also allows a precise profile to be carried out for each decoder and in this way, proposals can be made to users of these decoders relating to events or products that correspond to these requirements.

The table can also contain service data. The latter can, for example, describe the signal reception level, which in particular allows the sending of data to the user if the orientation of the antenna is not optimal and the user should thus contact a technician. This also allows the accurate positioning of a telecommunications satellite antenna in order to have an optimal coverage area. Other service data can, for example, describe the utilization period of a decoder or any kind of other data which may appear useful for obtaining the optimal functioning of the system and for calculating statistics, as previously described. The service data can also contain data related to software versions or modification dates of this softwares.

This information is also collected by the master or contract security module and is then transmitted to the management centre when this module is introduced into a decoder connected to an online modem.

If the subscriber's decoder equipment does not include a modem or if none of the decoders is connected to a telephone line, it is possible to request the subscriber to send the contract security module by mail. In this case, the management centre which requests this module to be sent can make arrangements so that no interruption of the decoding functions will occur as long as this module is outside this subscriber's home. This can be achieved by checking the temporary deactivation values and by increasing those that are at risk of decreasing to zero during the period in which the subscriber does not dispose of his contract module. The management centre can increase the subscriber's credit since said centre knows exactly the amount that has been consumed.

Receiving all the data of all the decoders registered under the name of one subscriber presents the advantage of generating one single invoice for events consumed by each subscriber. Furthermore, this includes a deterrent effect, similar to that mentioned in the object of the invention, since a subscriber who has resold his security module/decoder set to another user, receives the invoice of this other user. Furthermore, in the case where the impulse purchase is possible, the subscriber cannot control the amount of impulse purchases consumed by the other user and would thus be charged with the corresponding amounts on his invoice.

FIGS. 7a to 7d illustrate different decoder architecture that can be used in the device of the invention. The device in FIG. 7a shows a conventional decoder including an internal decryption module D and a removable security module ICC1. This is the most common structure and corresponds to the description above.

FIG. 7b represents a decoder as illustrated in FIG. 7a, including moreover a second security module reader. In this case, the slave security module ICC1 associated with the decoder can be left in decoder.

The second reader for its part can receive the master security module ICC1 or the contract module when this module must be used.

FIG. 7c shows an embodiment in which the decoder includes, on one hand a reader for a security module ICC_{C} and on the other hand, an integrated security module ICC1 in the decoder and realized in the form of a conventional electronic box. Under normal operating conditions, the security module integrated in the decoder is generally used. When the counter must be reinitialized, the external security module is used. This security module is by definition a contract module. This embodiment also allows the use of the removable module when the internal module is no longer operational, for example after an important change of the functions carried out by this module.

FIG. 7d is similar to FIG. 7c, the difference being that the internal security module ICC1 is integrated into one of the integrated circuits of the descrambling module D.

The functions of the security module can also be integrated into the descrambling module D.

In the description above, it has been admitted that the first security module ICC1 is the master module if the subscriber does not dispose of a contract module. In the case where the subscriber disposes of a contract module, the latter takes the role of master. For this reason, except when explicitly mentioned in the text, the master security module can be one of the security modules paired to a decoder, to which the master function has been assigned, or the contract module.

1-19. (canceled)

20. Decoder for processing Pay-TV data, this decoder being associated to at least one removable security module by means of identification data contained in said decoder and in the security module, this decoder including a descrambling module, wherein the decoder furthermore includes means to deactivate the processing of Pay-TV data as well as a counter acting on said deactivation means according to its content.

21. Decoder according to claim 20, wherein it furthermore includes at least one memory containing specific identification data of a security module different to that to which the decoder is associated, and means for comparing the specific identification data stored in the memory with the identification data of the security module contained in the decoder, and in that the counter is initialized by the means for comparing the identification data.

22. Decoder according to claim 20, wherein it includes a deactivation value and means for comparing this deactivation value with the content of said counter.

23. Decoder according to claim 22, wherein the deactivation value is a duration, a date or a numerical value.

24. Decoder according to claim 20, wherein it includes means for receiving a command acting on the content of said counter.

25. Decoder according to claim 24 locally connected to a security module, wherein said reception means receive a command from said security module, acting on the content of said counter.

26. Pay-TV data management system including at least two decoders, each decoder being associated to at least one removable security module by means of identification data contained in said decoder and in said security module, these decoders including a descrambling module and means to deactivate the processing of the Pay-TV data, wherein the decoders furthermore includes a counter that acts on said deactivation means, and in that at least one of the security modules is declared as master and includes means for reinitializing said decoder counters.

27. Data management system according to claim 26, wherein the decoders include a memory containing identification data relative to the master security module and means for comparing the identification data stored in said memory with the identification data of the security module contained in the decoder, and wherein the counter of each decoder is initialized by said means for comparing said identification data.

28. Data management system according to claim 26, wherein only the module that has been declared as master includes the reinitialization means for said counters.

29. Data management system according to claim 26, wherein it includes a supplementary security module as compared to the number of decoders, this supplementary security module being the module declared as master and comprising the means for reinitializing said decoder counters.

30. Management process for at least two decoders for processing Pay-TV data, said decoders being associated to a subscriber and including means to deactivate the processing of Pay-TV data and a counter that acts on said deactivation means, each subscriber having at least two removable security modules that can be locally connected to at least one decoder, this process comprising the steps of:
determining of at least one master security module among the security modules belonging to a subscriber,
storing of the identification data of the master security module in each of the subscriber's decoders,
deactivating, by means of the counter, of the data processing decoder according to at least one predefined criterion,
reinitializing of the counter by introducing the master security module into the deactivated decoder.

31. Process according to claim 30, wherein it includes a verification step of the conformity of the identification data of the master security module.

32. Process according to claim 31, wherein the verification step of the conformity of the master security module includes an authentication step of a unique identification number of said security module by means of a pairing key between this master security module and the decoder to be reactivated.

33. Process according to claim 30, wherein the deactivation of the data processing is carried out furthermore by sending a message to at least one of the subscriber's decoders, this message being sent by a management centre.

34. Process according to claim 30, wherein the reinitialization of the counter is carried out on the basis of a deactivation value stored in each decoder.

35. Process according to claim 34, wherein said deactivation value is transmitted to the decoders by means of an authorization command EMM.

36. Process according to claim 30, the decoder being connected to a slave security module that is not authorized to reinitialize the counter of said decoder, wherein it includes the following steps:
storing of the Pay-TV data processing activity in the decoder,
detecting the insertion of the master security module,
transferring the data of the processing activity to this master security module.

37. Process according to claim 30, wherein the processing data stored in the master security module are transmitted to a management centre.

38. Process according to claim 36, wherein the processing data stored in the master security module are transmitted to a management centre.

39. Process according to claim 37, wherein service data connected to the subscriber is transmitted to said management centre.

40. Process according to claim 38, wherein service data connected to the subscriber is transmitted to said management centre.
